(19) United States
(12) Patent Application Publication
(10) Pub. No.: US 2009/0231490 A1
(43) Pub. Date: Sep. 17, 2009

(54) METHOD AND SYSTEM FOR AUTOMATICALLY CHANGING CAPTION DISPLAY STYLE BASED ON PROGRAM CONTENT

(75) Inventors: Huang-Bin CHEN, Taipei (TW); Wen-Chin LEE, Taipei (TW); Tien-Hsin KUO, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ALI CORPORATION, Taipei (TW)

(21) Appl. No.: 12/132,078

(22) Filed: Jun. 3, 2008

(30) Foreign Application Priority Data
Mar. 13, 2008 (CN) 200810081782.0

(51) Int. Cl. H04N 7/00

(52) U.S. Cl. 348/468; 348/E07.001

(57) ABSTRACT

A method for automatically changing caption display style based on program content is disclosed. Plural caption parameters for each program content type are pre-defined. When a TV program is switched, a program system information protocol (PSIP) is searched to confirm program content type of the TV program. Captions of the TV program are decoded using a caption decoder based on program content type and corresponding caption parameters and the captions of the TV program are displayed according to the caption parameters relating to the program content type.

### CROSS REFERENCE TO RELATED APPLICATIONS

This Application claims priority of China Patent Application No. 200810081782.0, filed on Mar. 13, 2008, the entirety of which is incorporated by reference herein.

### BACKGROUND OF THE INVENTION

1. Field of the Invention

The invention relates to an image processing system, and more particularly to a method and system for automatically changing caption display style based on program content.

2. Description of the Related Art

Closed caption (called CC hereafter) is not the same as digital versatile disc (DVD) subtitles and is specially designed for describing events for currently viewed scenes. Background sounds or important transition properties, for example, can be prompted using the closed caption setting. Additionally, closed caption is prepared for people with hearing loss or viewers watching a program without audio equipment.

With respect to current closed caption processing techniques, adjustable caption parameters at least comprise Style, Font Size, Font Style, Foreground (Fg) Color, Foreground (Fg) Opacity, Background (Bg) Color, Background (Bg) Opacity, Edge Type, Edge Color, and so forth. When watching a TV program, someone may want to enlarge the font size, someone may want to condense the font size, and someone may want to close the caption. For convenience, identical parameter settings are applied to the type of the TV program, and are implemented by a program system information protocol (PSIP).

FIG. 1 is a schematic view of a conventional recordable digital receiver system.

Caption settings are adjusted using a control unit 120 via a user interface 110 and are stored in a storage unit 130, and the adjusted caption settings are transmitted to a caption decoder 140. A demultiplexer (Demux) 150 converts received program streams into different data types of transport streams and transmits the transport streams to a video unit 160.

The video unit 160 filters received caption data and then transmits the filtered caption data to the caption decoder 140. The caption decoder 140 decodes the caption data according to the user settings (the caption settings as described) and transmits the decoded caption data to a video synthesizer 170. The video synthesizer 170 synthesizes the received caption data from the caption decoder 140 and the received multimedia data from the video unit 160 and then transmits the synthesis result to a display unit 180 for display.

Such caption settings only provide a single processing mode, which cannot satisfy individual caption settings for different program types, that enables users to watch TV programs with their own display modes.

Thus, a method and system for automatically changing caption display style based on program content is desirable.

### BRIEF SUMMARY OF THE INVENTION

Methods for automatically changing caption display style based on program content are provided. An exemplary embodiment of a method for automatically changing caption display style based on program content comprises the following. Plural caption parameters for each program content type are pre-defined. When a TV program is switched, a program system information protocol (PSIP) is searched to confirm program content type of the TV program. Captions of the TV program are decoded using a caption decoder based on program content type and corresponding caption parameters and the captions of the TV program are displayed according to the caption parameters relating to the program content type.

Systems for automatically changing caption display style based on program content are provided. An exemplary embodiment of a system for automatically changing caption display style based on program content comprises a control unit, a caption decoder, a video unit, and a display unit. The control unit pre-defines plural caption parameters for each type of program content when a TV program stream is received, determines program content type of the TV program, and transmits the determination result to the caption decoder. The video unit filters caption information of the TV program according to the determination result and transmits the filtered result to the caption decoder. The caption decoder decodes captions of the TV program according to the filtered result and the program content type. The display unit displays the captions of the TV program according to the decoded result.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional recordable digital receiver system;

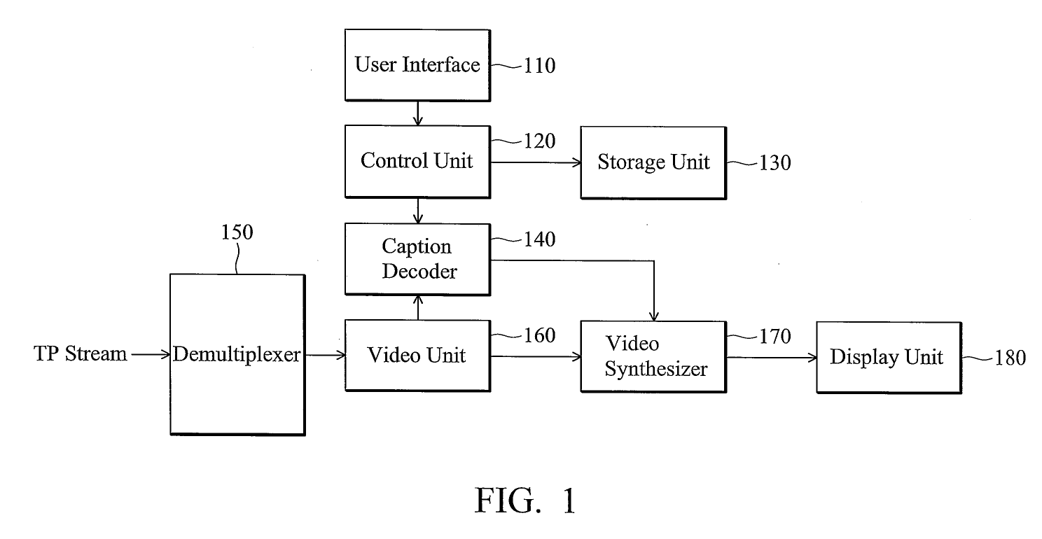

FIG. 2 is a schematic view of caption parameter adjustment of the present invention.

FIG. 3 is a flowchart of a method for automatically changing caption display style based on program content of the present invention.

FIG. 4 is a schematic view of a system for automatically changing caption display style based on program content of the present invention.

FIG. 5 is a schematic view of caption parameter adjustment of another embodiment of the present invention.

FIG. 6 is a schematic view of caption parameter adjustment of another embodiment of the present invention.

### DETAILED DESCRIPTION OF THE INVENTION

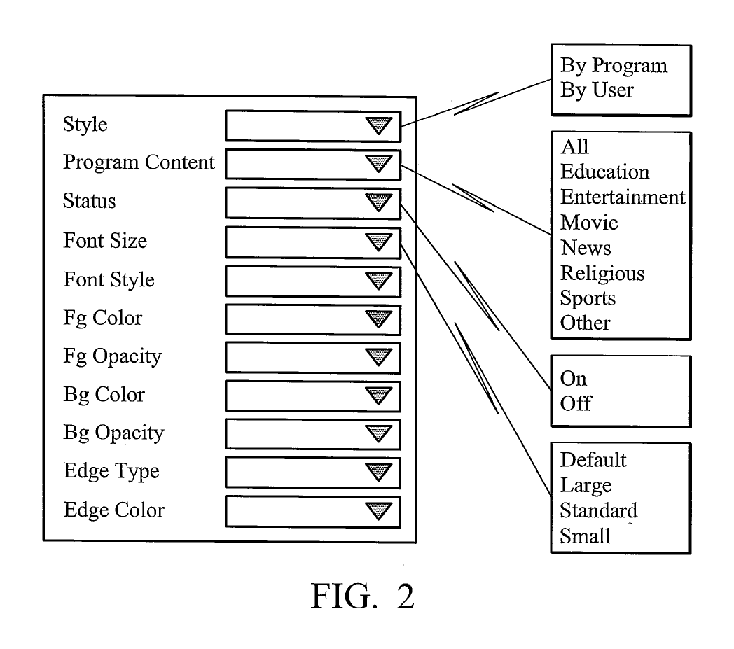

Several exemplary embodiments of the invention are described with reference to FIGS. 2 through 6, which generally relate to changing caption display style based on program content. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method and system for automatically changing caption display style based on program content.

FIG. 2 is a schematic view of caption parameter adjustment of the present invention. As shown in FIG. 2, adjustable caption parameters at least comprise Style, Program Content, Status, Font Size, Font Style, Foreground (Fg) Color, Foreground (Fg) Opacity, Background (Bg) Color, Background (Bg) Opacity, Edge Type, Edge Color, and so forth.

The Style parameter can be set to “By Program” or “By User”. Captions of TV programs are displayed based on a preset setting defined by a service provider (a cable television system, for example) when the style parameter is set to “By Program”. When the Style parameter is set to “By User”, each caption parameter can be respectively set according to different types of TV programs. The caption, for example, can be closed (Status=Off), when a sports program is being watched, or enlarged, when a news program is being watched.

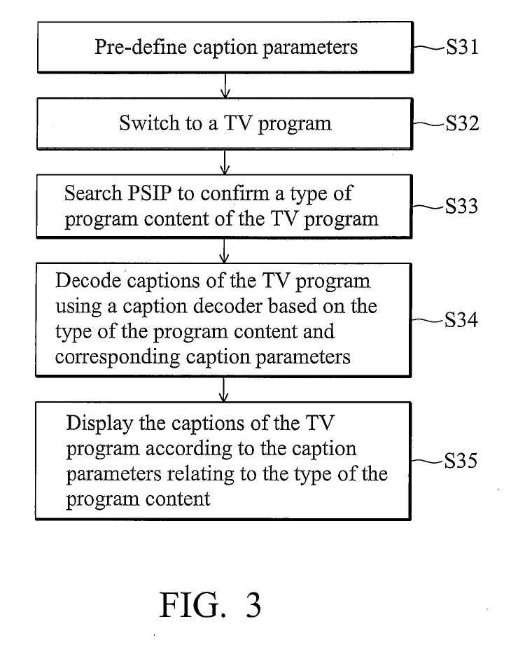

FIG. 3 is a flowchart of a method for automatically changing caption display style based on program content of the present invention.

Plural caption parameters for each program content type are pre-defined (step S31) and stored in a storage unit (Read Only Memory (ROM), for example). When a TV program is switched (step S32), a program system information protocol (PSIP) is searched to confirm program content type of the TV program (step S33). Captions of the TV program are decoded using a caption decoder based on program content types and corresponding caption parameters (step S34), and the captions of the TV program are displayed according to the caption parameters relating to the program content type (step S35).

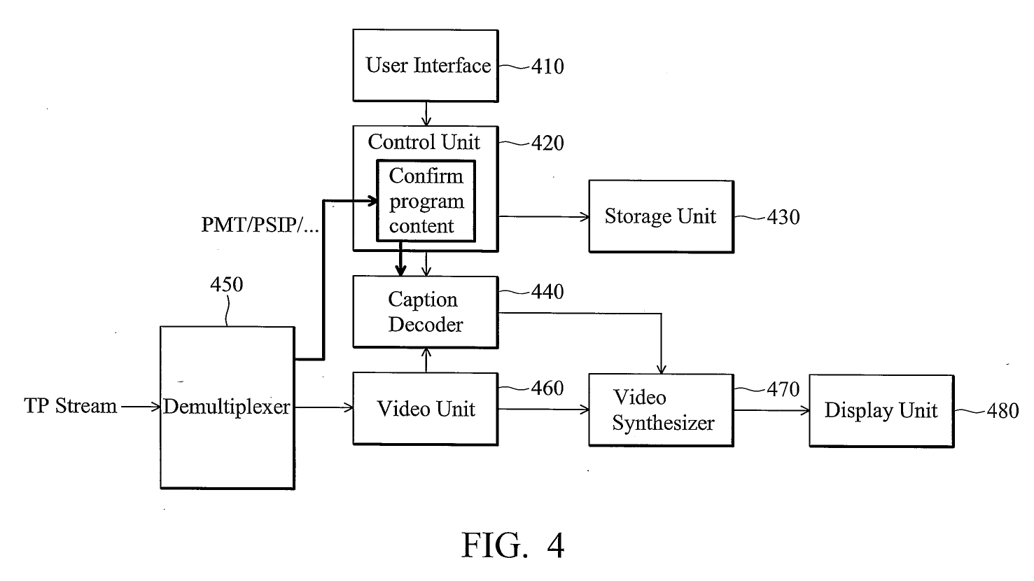

FIG. 4 is a schematic view of a system for automatically changing caption display style based on program content of the present invention.

The system at least comprises a user interface 410, a control unit 420, a storage unit 430, a caption decoder 440, a demultiplexer (Demux) 450, a video unit 460, a video synthesizer 470, and a display unit 480.

Caption settings are adjusted using the control unit 420 via the user interface 410 and are stored in the storage unit 430, and the adjusted caption settings are transmitted to the caption decoder 440. When a program stream is received, the demultiplexer 450 transmits PSIP information (comprising program map table (PMT), PSIP, and so forth) to the control unit 420, converts caption information and multimedia data of the program stream into different data types of transport streams, and transmits the transport streams to the video unit 460.

The control unit 420 determines program content type of the program stream and transmits the determination result to the caption decoder 440. The video unit 460 filters caption information of the program stream according to the determination result and transmits the filtered result to the caption decoder 440 and the remaining multimedia data (comprising video data, audio data, and so forth) to the video synthesizer 470.

The caption decoder 440 decodes the caption information of the program stream according to the filtered result and the program content type and transmits the decoded caption information to the video synthesizer 470. The video synthesizer 470 synthesizes the multimedia data and the decoded caption information and transmits to the display unit 480 for display.

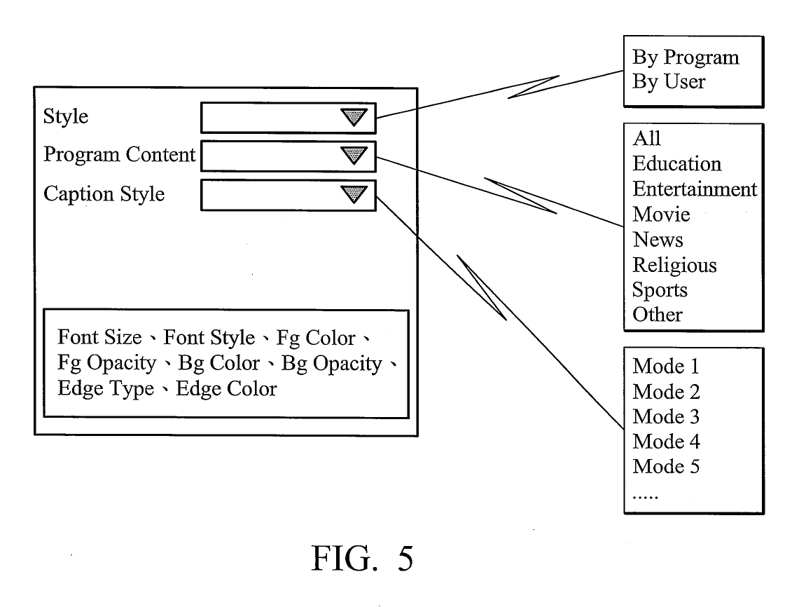

FIG. 5 is a schematic view of caption parameter adjustment of another embodiment of the present invention. As shown in FIG. 5, adjustable caption parameters comprise Style, Program Content, and Caption Style. The Style parameter can be set to “By Program” or “By User”. The Program Content parameter provides All, Education, Entertainment, News, Sports, and so forth. The Caption Style parameter provides Mode 1, Mode 2, Mode, 3, and so forth. Each program contents is defined based on a selected mode, comprising presetting the font size, font style, foreground color, foreground opacity, background color, background opacity, edge type, edge color, and so forth. When the Style parameter is set to “By User, different caption styles can be applied to different program contents. The Mode 1, for example, can be applied when a sports program is being watched while the Mode 4 can be applied when a news program is being watched.

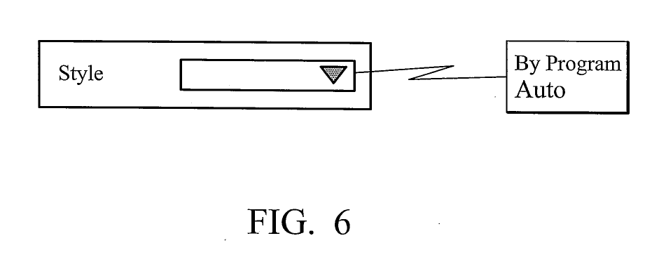

FIG. 6 is a schematic view of caption parameter adjustment of another embodiment of the present invention. As shown in FIG. 6, adjustable caption parameters comprise Style, Program Content, and Caption Style. The Style parameter can be set to “By Program” or “Auto”. When the Style parameter is set to “By Program”, captions of TV programs are displayed based on preset settings. When the style parameter is set to “Auto ”, caption styles are automatically and randomly applied based on different program content types.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for automatically changing caption display style based on program content, comprising:
pre-defining plural caption parameters for each program content type;
when a TV program is switched, confirming program content type of the TV program;
decoding captions of the TV program according to program content type; and
displaying the captions of the TV program according to the caption parameters relating to the program content type.

2. The method for automatically changing caption display style based on program content as claimed in claim 1, wherein the caption parameters for each program content type are stored in a storage unit.

3. The method for automatically changing caption display style based on program content as claimed in claim 1, wherein the step of confirming program content type of the TV program is implemented by searching a program system information protocol (PSIP).

4. The method for automatically changing caption display style based on program content as claimed in claim 1, wherein the step of decoding the captions of the TV program is implemented using a caption decoder based on program content type and corresponding caption parameters

5. The method for automatically changing caption display style based on program content as claimed in claim 1, wherein the caption parameters comprises a style parameter set to “By Program” or “By User”.

6. The method for automatically changing caption display style based on program content as claimed in claim 5, wherein the captions of the TV program is displayed based on a preset setting defined by a service provider when the style parameter is set to “By Program”.

7. The method for automatically changing caption display style based on program content as claimed in claim 5, wherein the captions of the TV program is displayed based on the caption parameters relating to the style parameter when the style parameter is set to “By User”.

8. The method for automatically changing caption display style based on program content as claimed in claim 1, wherein different settings are assigned to each of the caption parameters to generate plural caption display modes and, when the TV program is received, one of the caption display modes is automatically selected to display the captions of the TV program.

9. A system for automatically changing caption display style based on program content, comprising:
a control unit;
a caption decoder;
a video unit; and
a display unit, wherein the control unit pre-defines plural caption parameters for each program content type, when a TV program stream is received, the control unit determines program content type of the TV program and transmits the determination result to the caption decoder, the video unit filters caption information of the TV program according to the determination result and transmits the filtered result to the caption decoder, the caption decoder decodes captions of the TV program according to the filtered result and the program content type, and the display unit displays the captions of the TV program according to the decoded result.

10. The system for automatically changing caption display style based on program content as claimed in claim 9, further comprising a storage unit, storing the caption parameters for each program content type.

11. The system for automatically changing caption display style based on program content as claimed in claim 9, further comprising a user interface, assigning different settings to each of the caption parameters to generate plural caption display modes.

12. Programming for automatically changing caption display style based on program content, the programming embodied in a computer readable medium having instructions for:
pre-defining plural caption parameters for each program content type;
when a TV program is switched, confirming program content type of the TV program;
decoding captions of the TV program according to program content type; and
displaying the captions of the TV program according to the caption parameters relating to the program content type.

13. The computer-readable storage medium as claimed in claim 12, wherein the confirming program content type of the TV program is implemented by searching a PSIP.

14. The computer-readable storage medium as claimed in claim 12, wherein the decoding the captions of the TV program is implemented using a caption decoder based on program content type and corresponding caption parameters

15. The computer-readable storage medium as claimed in claim 12, wherein the captions of the TV program is displayed based on a preset setting defined by a service provider when a style parameter of the caption parameters is set to “By Program”.

16. The computer-readable storage medium as claimed in claim 12, wherein the captions of the TV program is displayed based on the caption parameters relating to the style parameter when a style parameter of the caption parameters is set to “By User”.

17. The computer-readable storage medium as claimed in claim 12, wherein different settings are assigned to each of the caption parameters to generate plural caption display modes and, when the TV program is received, one of the caption display modes is automatically selected to display the captions of the TV program.
